(19) United States
(12) Patent Application Publication
(10) Pub. No.: US 2002/0081029 A1
(43) Pub. Date: Jun. 27, 2002

(54) Subject area extracting method and image pick up apparatus using the same

(75) Inventor: Atsushi Marugame, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 10/026,687

(22) Filed: Dec. 27, 2001

(30) Foreign Application Priority Data
Dec. 27, 2000 (JP) 398184/2000

(51) Int. Cl. G06K 9/46

(52) U.S. Cl. 382/190

(57) ABSTRACT

An image pickup apparatus comprises a space-frequency characteristic pattern irradiating section which irradiates a visible light which has passed through an optical filter having a predetermined space-frequency characteristic to the target object; a camera; a difference image generating section which generates a difference image between a first and a second image each picked up by the camera when the visible light is irradiated or not irradiated from the space-frequency characteristic pattern irradiating section; a space-frequency domain transforming section which transforms the generated difference image to a space-frequency domain to acquire a space-frequency characteristic of each pixel of the difference image; a space-frequency pattern collating section which collates the space-frequency characteristic of each acquired pixel with the space-frequency characteristic of the optical filter; and a subject image generating section which generates a subject image from which the subject area has been extracted based on a result of collation.

### BACKGROUND OF THE INVENTION

1. Field of the Invention

The present invention relates to a subject area extracting method which picks up the image of a subject as a target to be picked up by irradiating light to the subject and extracts the area of the subject from the acquired image, and an image pickup apparatus which uses the method.

2. Description of the Related Art

A method which irradiates visible rays or infrared rays to a subject is known as a method which picks up a subject as a target to be picked up together with the background or the like and extracts the area of the subject from the acquired optical image. Such a method is described in Unexamined Japanese Patent Application KOKAI Publication No. H2-304680, Unexamined Japanese Patent Application KOKAI Publication No. H6-268929, Unexamined Japanese Patent Application KOKAI Publication No. H7-154777 and Unexamined Japanese Patent Application KOKAI Publication No. H10-243387.

Unexamined Japanese Patent Application KOKAI Publication No. H2-304680 discloses a technique that compares an image acquired with infrared light irradiated to a subject with an image acquired with no infrared light irradiated to the subject to thereby acquire a difference image between both images and acquires image information of the subject based on the acquired difference image.

Unexamined Japanese Patent Application KOKAI Publication No. H6-268929 discloses a projection image pickup apparatus that includes a projection section which irradiates light to a subject by repeatedly emitting light in one frame period, an optical section which acquires an optical image of the subject and divides the image into a plurality of optical image segments, a first photoelectric transforming section which acquires one of the image segments divided by the optical section and generates an image signal when light is emitted from the projection section, a second photoelectric transforming section which acquires the other image segments divided by the optical section and generates an image signal when light is not emitted from the projection section, immediately before or after the photoelectric conversion period of the first photoelectric transforming section, and a control/processing section which performs an operation on a difference image between the image signals output from the first and second photoelectric transforming sections and generates a video signal. The projection section has a light-emitting unit, such as a laser beam source, a LED, a discharge lamp or a strobe light source. The projection image pickup apparatus can identify a fast moving subject, such as a running vehicle, by comparing two image signals obtained by irradiating light repeatedly in one frame.

Unexamined Japanese Patent Application KOKAI Publication No. H7-154777 discloses a technique that irradiates infrared light to a subject, separates visible light and reflected infrared light, both received by light receiving means, from each other, and extracts, as the image of the subject, that visible light image in the entire visible light image formed from the separated visible light which lies in a mask area or an area where the separated reflected infrared light has a predetermined intensity.

Unexamined Japanese Patent Application KOKAI Publication No. H10-243387 discloses a technique that identifies the outline of a subject by radiating infrared light to the subject and picking up reflected light, and extracts the image of the subject from an image picked up by visible light based on the outline identified using infrared light.

### SUMMARY OF THE INVENTION

The techniques of the related art have the following shortcomings.

In case where visible light is irradiated to a target object and image processing is carried out based on a difference image between an non-irradiated image and an irradiated image, it is not possible to eliminate influences of light disturbance, such as flickering of fluorescent light, and noise produced by an image pickup apparatus.

The method that irradiates invisible light, such as infrared light, and extracts the area of a target object based on the intensity of the reflected light should irradiate intense invisible light depending on the ambient illumination conditions or the like. If the intensity of invisible light is increased too high, however, the luminance of the irradiated portion stays at the upper limit due to the restrictions on the dynamic range of the image pickup apparatus. This reduces the difference between that luminance and the luminance of the background. Because an infrared irradiating apparatus that can irradiate intense infrared rays is expensive, however, the cost of the overall apparatus increases considerably. Further, irradiating invisible light to a human body as a target object is not desirable for it may adversely affect the human body.

Accordingly, it is an object of the invention to provide a subject area extracting method which is not easily influenced by noise in an image pickup apparatus or light disturbance in case where the area of a target object in an image is extracted by irradiation of visible light alone, an image pickup apparatus which uses the method, and a subject area extracting program.

To achieve the object, according to the first aspect of the invention, there is provided an image pickup apparatus for extracting a subject area from a picked-up image of a target object as a subject. The image pickup apparatus comprises:

a space-frequency characteristic pattern irradiating section which irradiates a visible light which has passed through an optical filter having a predetermined space-frequency characteristic to the target object;

a camera which picks up the target object;

a difference image generating section which generates a difference image between a first image picked up by the camera when the visible light is irradiated from the space-frequency characteristic pattern irradiating section and a second image picked up by the camera when the visible light is not irradiated from the space-frequency characteristic pattern irradiating section;

a space-frequency domain transforming section which transforms the difference image generated by the difference image generating section to a space-frequency domain to acquire a space-frequency characteristic of each pixel of the difference image;

a space-frequency pattern collating section which collates the space-frequency characteristic of each pixel acquired by the space-frequency domain transforming section with the space-frequency characteristic of the optical filter; and

a subject image generating section which generates a subject image from which the subject area has been extracted based on a result of collation performed by the space-frequency pattern collating section.

It is preferable that the optical filter should have a space-frequency characteristic which localizes a power spectrum to a predetermined space-frequency when the difference image is transformed to the space-frequency domain. For example, the optical filter can be an optical filter whose visible light transparency rate changes in a sine wave form.

The space-frequency domain transforming section may transform a difference image into a space-frequency domain by Fourier transform or discrete cosine transform.

To achieve the object, according to the second aspect of the invention, there is provided an image pickup apparatus for extracting a subject area from a picked-up image of a target object as a subject. The image pickup apparatus comprises:

a space-frequency characteristic pattern irradiating section which irradiates a visible light which has passed through an optical filter having a predetermined space-frequency characteristic to the target object;

a camera which picks up the target object;

a processor; and

a storage which stores a program to be executed by the processor, wherein said processor:

generates a difference image between a first image picked up by the camera when the visible light is irradiated from the space-frequency characteristic pattern irradiating section and a second image picked up by the camera when the visible light is not irradiated from the space-frequency characteristic pattern irradiating section;

transforms the generated difference image to a space-frequency domain to acquire a space-frequency characteristic of each pixel of the difference image;

collates the acquired space-frequency characteristic of each pixel with the space-frequency characteristic of the optical filter; and

generates a subject image from which the subject area has been extracted based on a result of collation performed by the space-frequency pattern collating section.

The space-frequency characteristic pattern irradiating section may include the optical filter, a light source for irradiating light to the target object via the optical filter, and a light source controller which controls ON and OFF states of the light source and informs the processor of whether the light source is in the ON state or the OFF state.

Instead of the light source controller informing the processor of whether the light source is in the ON state or the OFF state, the processor may acquire first average brightness of the first image and second average brightness of the second image and determine, based on the first average brightness and the second average brightness, that the first image is an image picked up by the camera when the visible light is irradiated and the second image is an image picked up by the camera when the visible light is not irradiated.

To achieve the object, according to the third aspect of the invention, there is provided a subject area extracting method for extracting a subject area from a picked-up image of a target object as a subject. The method comprises the steps of:

irradiating a visible light which has passed through an optical filter having a predetermined space-frequency characteristic to the target object;

generating a difference image between a first image picked up when the visible light is irradiated and a second image picked up when the visible light is not irradiated;

transforming the generated difference image to a space-frequency domain to acquire a space-frequency characteristic of each pixel of the difference image;

collating the acquired space-frequency characteristic of each pixel with the space-frequency characteristic of the optical filter; and

generating a subject image from which the subject area has been extracted based on a result of collation.

To achieve the object, according to the fourth aspect of the invention, there is provided a program which makes a computer:

generate a difference image between a first image picked up when a visible light which has passed through an optical filter having a predetermined space-frequency characteristic is irradiated to a target object as a subject and a second image picked up when the visible light is not irradiated to the target object;

transform the generated difference image to a space-frequency domain to acquire a space-frequency characteristic of each pixel of the difference image;

collate the acquired space-frequency characteristic of each pixel with the space-frequency characteristic of the optical filter; and

generate a subject image from which the subject area has been extracted based on a collation result.

### BRIEF DESCRIPTION OF THE DRAWINGS

The object and other objects and advantages of the present invention will become more apparent upon reading of the following detailed description and the accompanying drawings in which:

FIG. 1 is a block diagram illustrating the structure of an image pickup apparatus according to a first embodiment of the invention;

FIG. 2 is a flowchart illustrating the operation of the image pickup apparatus in FIG. 1;

FIG. 3 is a diagram showing a power spectrum distribution when the space-frequency characteristic of an optical filter used in the image pickup apparatus in FIG. 1 is sine wave;

FIG. 4 is a diagram showing the space-frequency characteristic of the optical filter used in the image pickup apparatus in FIG. 1;

FIG. 5 is a diagram showing a mathematical expression for the power spectrum distribution shown in FIG. 3; and

FIG. 6 is a block diagram illustrating the structure of an image pickup apparatus according to a second embodiment of the invention.

### DETAILED DESCRIPTION OF THE PREFERRED EMBODIMENTS

Image pickup apparatuses according to preferred embodiments of the invention will now be described with reference to the accompanying drawings.

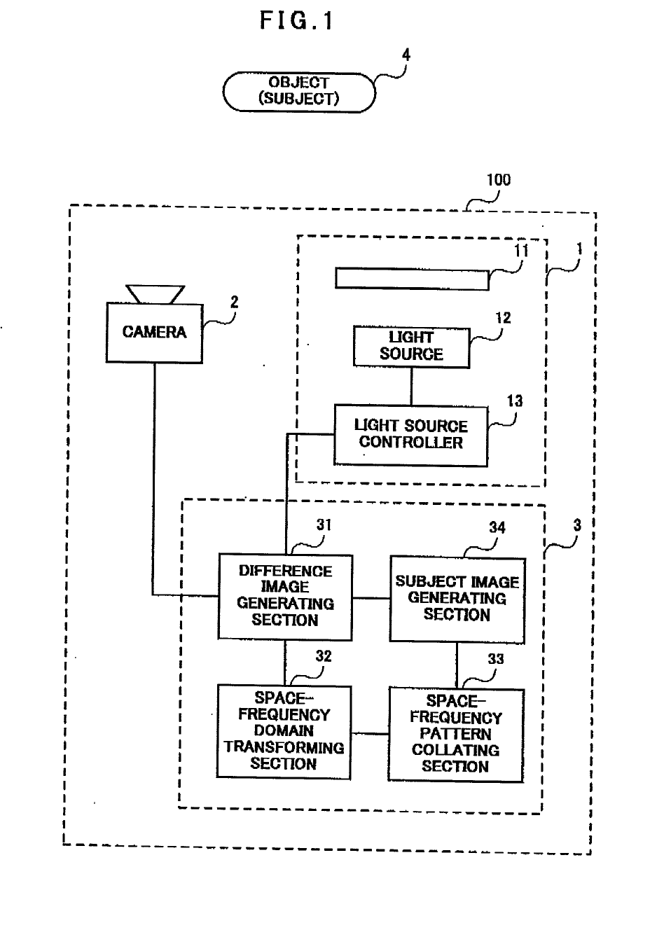

FIG. 1 is a block diagram illustrating the structure of an image pickup apparatus 100 according to the first embodiment of the invention. As shown in FIG. 1, the image pickup apparatus 100 includes a space-frequency characteristic pattern irradiating section 1, a camera 2 which picks up the image of an object 4 and a subject extracting section 3 which extracts a target subject from an obtained image. The space-frequency characteristic pattern irradiating section 1 includes an optical filter 11 whose light transparency rate has a predetermined space-frequency characteristic, a light source 12, such as a halogen lamp, and a light source controller 13 which controls the ON/OFF state of the light source 12. The camera 2 is, for example, a video camera, a still camera or the like. The subject extracting section 3 includes a difference image generating section 31, a space-frequency domain transforming section 32, a space-frequency pattern collating section 33 and a subject image generating section 34.

The difference image generating section 31 has an image memory capable of storing at least three images and generates a difference image from two images that are obtained when the light source 12 is turned on and off. The space-frequency domain transforming section 32 performs a space-frequency domain transformation on the difference image. The space-frequency pattern collating section 33 collates the acquired space-frequency with a predetermined collation pattern. The subject image generating section 34 extracts a subject area based on the result of collation executed by the space-frequency pattern collating section 33, and produces a subject image.

The characteristic of the optical filter 11 will be discussed below with reference to FIG. 4. The optical filter 11 has such a characteristic that the transparency rate of visible light changes in a sine form. The low-transparency rate portion has a transparency rate of 0% and the high-transparency rate portion has a transparency rate of 100%. As the light source 12 is turned on and irradiates visible light to a target object, the visible light passes through the optical filter 11, thus forming a vertical stripe pattern on the surface of the object.

It is desirable that the wavelength of the sine wave of the optical filter 11 should be selected in accordance with the size of the object to which light is irradiated. That is, a wave with a short wavelength is used when the target object is small, whereas a wave with a long wavelength is used when the target object is large. If the wavelength is too short, however, it is difficult to eliminate a noise component so that the wavelength of the sine wave is determined based on an expected noise component and the size of the target object. The space-frequency characteristic of the optical filter 11 is not limited to a sine wave but may be of any form which localizes the power spectrum to a specific space-frequency when an image is transformed to a space-frequency domain.

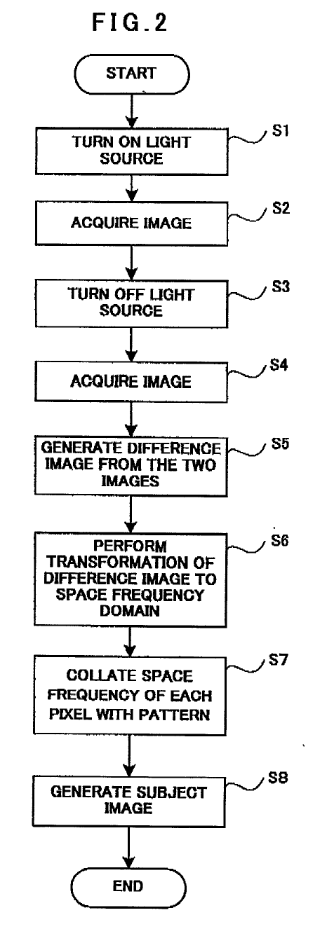

The operation of the image pickup apparatus 100 shown in FIG. 1 will now be discussed with reference to FIG. 2.

First, the light source controller 13 turns on the light source 12 (step S1) and notifies the difference image generating section 31 of the ON state of the light source 12. As a result, the light that is emitted from the light source 12 passes through the optical filter 11 to be irradiated on the object 4. At this time, a stripe pattern according to the characteristic of the optical filter 11 is formed on the surface of the object 4.

Next, the difference image generating section 31 acquires an image picked up by the camera 2 (Step S2). The acquired image is stored in a first area of the image memory in the difference image generating section 31. When the acquisition of the image is completed, the difference image generating section 31 notifies the light source controller 13 of the end of the image acquisition. In response to the notification, the light source controller 13 turns off the light source 12 (step S3) and notifies the difference image generating section 31 of the OFF state of the light source 12. At the time the light source controller 13 turns on and off the light source 12, the ON and OFF actions may be carried out in accordance with an instruction from the difference image generating section 31.

Next, the difference image generating section 31 acquires an image picked up by the camera 2 and stores the image in the image memory in the difference image generating section 31 (step S4). The acquired image is stored in a second area different from the first area where the image has been stored in step S2. At this point of time, the image obtained when the light source 12 is turned on and the image obtained when the light source 12 is turned off are respectively stored in the two areas in the image memory.

In the above-described operation, the light source controller 13 notifies whether the light source 12 is in the ON state or the OFF state and an image is picked up based on the notification. In case where the camera 2 is a video camera, however, the difference image generating section 31 may acquire an average brightness in the obtained image and determines based on the average brightness whether or not the image sent from the camera 2 is the one when the light source 12 is turned on or the one when the light source 12 is turned off.

Next, the difference image generating section 31 generates a difference image from the images stored in the two areas in the image memory (step S5). The difference image is produced by acquiring a difference between brightness values of corresponding pixels in both images. Then, the difference image generating section 31 sends the generated difference image to the space-frequency domain transforming section 32.

Next, the space-frequency domain transforming section 32 provides a window of a predetermined size around a pixel of interest in the difference image and transforms the difference image to a space-frequency domain using pixels included in the window to compute a power spectrum in the window (step S6). The transformation of the difference image to a space-frequency domain can be accomplished by Fourier transform or discrete cosine transform. The distribution of the power spectrum in each window represents a space-frequency characteristic in the vicinity of the pixel of interest. Let the distribution of the power spectrum in the vicinity of the pixel of interest that has been acquired by the transformation be the space-frequency characteristic of the pixel of interest. As this process is carried out for every pixel of the difference image, the space-frequency characteristic of each pixel is acquired. As a result, the distribution of the power spectrum has been acquired for all the pixels.

Next, the space-frequency pattern collating section 33 collates the power spectrum distribution of each pixel with a collation pattern which has been prepared beforehand (step S7). Then, the space-frequency pattern collating section 33 determines a similarity between the power spectrum distribution of each pixel and the collation pattern, and considers that the pixel is a portion where the light emitted from the light source 12 has been irradiated, if the similarity is strong. As the collation process is carried out for all the pixels, it is possible to determine whether or not each pixel is a portion where the light from the light source 12 has been irradiated.

Although every spectrum of the power spectrum distribution of those pixels where the light from the light source 12 is not irradiated is ideally “0”, a component caused by a difference between ambient lights when the light that has passed through the optical filter 11 is irradiated and when the light is not irradiated appears actually. Also, a component caused by a noise that is produced in the image pickup apparatus or the like appears actually. However, the space-frequency component of the pattern light is produced more intensely than the above mentioned components in the power spectrum distribution of a pixel where a pattern light is not irradiated.

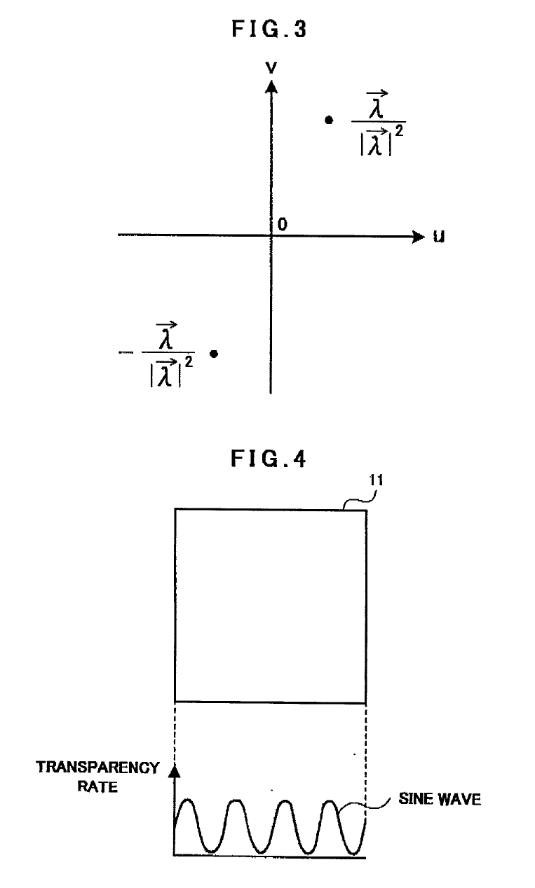

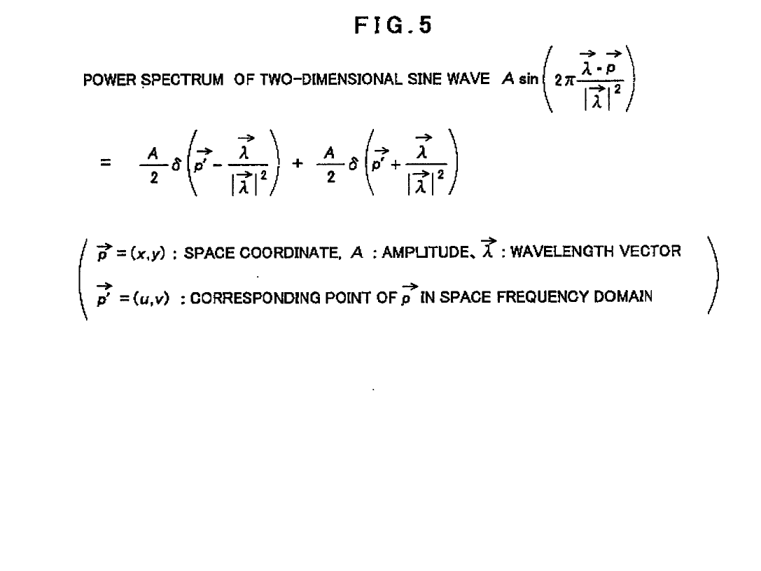

FIG. 3 shows a power spectrum distribution when the space-frequency characteristic of the optical filter 11 is made sine wave and the light from the light source 12 is irradiated. This power spectrum is expressed by a mathematical expression given in FIG. 5. As apparent from FIG. 3 and the mathematical expression, the power spectrum has components which are localized in two space-frequency domains symmetrical with respect to the origin and are far stronger than the component caused by the difference of the ambient light or the noise produced by the image pickup apparatus or the like.

Accordingly, only the area of a target object as a subject can be extracted by comparing the power spectrum distribution of each pixel with the power spectrum distribution of the irradiated pattern and selecting only the pixel whose power spectrum distribution is identical to that of the irradiated pattern. In consideration of the fact that the difference ambient light or noise image often becomes a low-frequency component or high-frequency component near a DC, if those components are eliminated beforehand by a band-pass filter, collation of the power spectrum distributions can be executed more easily.

Next, the subject image generating section 34 generates a subject image based on the result of the collation in the space-frequency pattern collating section 33 (step S8). The generation of the subject image is accomplished by generating a binary image that has a value of “1” for those pixels which correspond to portions where the light from the light source 12 is irradiated and has a value of “0” for those pixels which correspond to portions where the light from the light source 12 is not irradiated and extracting only those pixels which correspond to pixels in the binary image that have a value of “1” from the image obtained when the light source 12 is turned off.

A liquid crystal filter may be used as the optical filter 11 so that at the time of picking up an image, the filter is synchronized with the ON/OFF state of the light source 12 to change the space-frequency characteristic pattern to be irradiated. At this time, collation patterns are pre-stored in the space-frequency pattern collating section 33 for the respective space-frequency characteristic patterns to be irradiated and the power spectrum distribution of each pixel is collated with the collation pattern that corresponds to the irradiated pattern. This scheme can change the space-frequency characteristic pattern to be irradiated in accordance with the surface of a target object whose image is to be picked up.

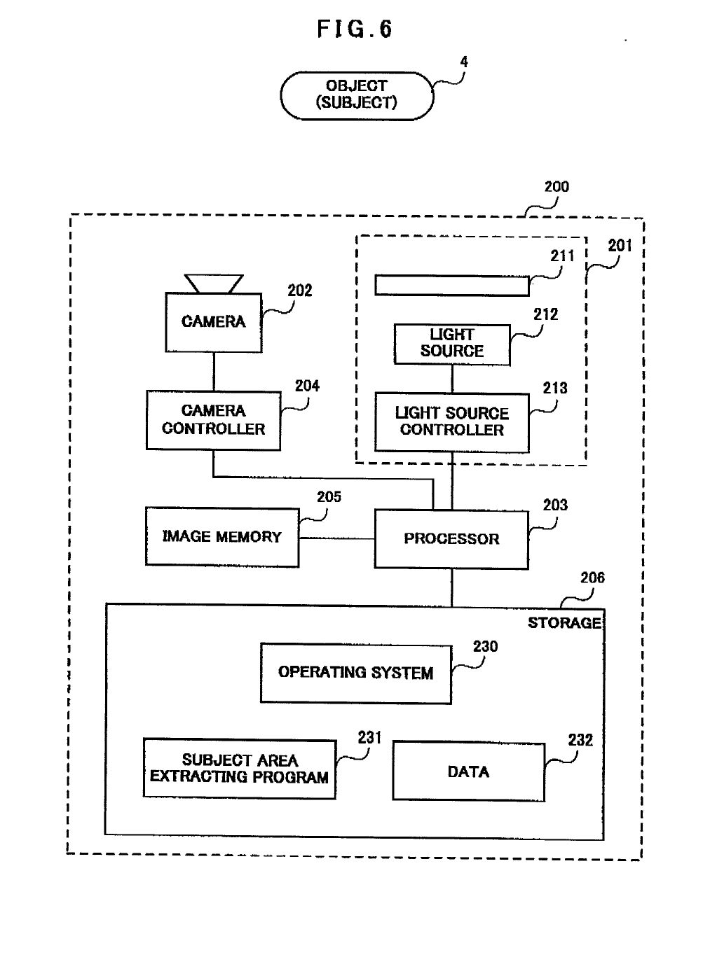

An image pickup apparatus according to the second embodiment of the invention will be discussed below with reference to FIG. 6. FIG. 6 is a block diagram illustrating the structure of the image pickup apparatus 200 according to the second embodiment of the invention. As shown in FIG. 6, the image pickup apparatus 200 has a space-frequency characteristic pattern irradiating section 201, a camera 202, a processor 203, a camera controller 204, an image memory 205 and a storage 206. The space-frequency characteristic pattern irradiating section 201, like the space-frequency characteristic pattern irradiating section 1 in the image pickup apparatus 100 of the first embodiment, includes an optical filter 211, a light source 212, such as a halogen lamp, and a light source controller 213 which controls the ON/OFF state of the light source 212. The image pickup apparatus 200 of the second embodiment basically operates in the same way as the image pickup apparatus 100 of the first embodiment except that the functions of the subject extracting section 3 are accomplished by a program that is executed by the processor 203. The optical filter 211, the light source 212, the light source controller 213 and the camera 202 may be the same as those used in the image pickup apparatus 100 of the first embodiment.

The processor 203 executes a program stored in the storage 206 and gives instructions to the light source controller 213 and the camera controller 204. The image memory 205 stores an image picked up by the camera 202. The camera controller 204 acquires an image picked up by the camera 202 based on an instruction from the processor 203 and sends the image to the processor 203. The structure may be modified in such a way that the camera controller 204 directly stores a picked-up image in the image memory.

The storage 206 is constituted by a storage device, such as a semiconductor memory or a hard disk, and stores programs, such as an operating system (OS) 230 and a subject area extracting program 231, and various kinds of data 232. The OS 230 may be an ordinary general-purpose operating system, a general-purpose operating system which has an additional capability of controlling the light source controller or camera controller, or an operating system for an embedded system. The subject area extracting program 231 is a program which achieves the functions of the subject extracting section 3 in the image pickup apparatus 100 of the first embodiment, i.e., the functions illustrated in FIG. 2. The data 232 is what is generated or referred when the processor 203 executes a program, such as the OS 230 or the subject area extracting program 231, and includes the aforementioned collation pattern or the like.

The subject area extracting program 231 may be prerecorded in a ROM or the like that constitutes the storage 206. Alternatively, the image pickup apparatus 200 may be constructed in such a way as to have a mechanism which reads a program recorded on a computer-readable recording medium, so that the subject area extracting program is recorded in the computer-readable recording medium and is read into the storage 206 under the control of the processor 203.

In the embodiment, instead of equipping the image pickup apparatus 200 with the processor 203, the storage 206, etc., an ordinary computer system may be used to which the space-frequency characteristic pattern irradiating section 201, the camera 202 and the camera controller 204 are connected. As a program which achieves the functions shown in FIG. 2 is recorded in a computer-readable recording medium and the recorded program is loaded into the computer system and executed, the subject area extracting process can be carried out.

The ordinary computer system may be a system that is constructed by, for example, a personal computer or the like, and includes an OS and hardware, such as peripheral devices. In case where the computer system uses a WWW (World Wide Web) system, the computer system should include a homepage providing environment (or display environment). A computer-readable recording medium means a portable medium, such as a floppy disk, magneto-optical disk, ROM or CD-ROM, and a storage device installed in the computer system. Further, the “computer-readable recording medium” should include a type which retains a program for a given period of time, such as a volatile memory (RAM) in a computer system which becomes a server or a client in case where the program is transmitted via a network, such as the Internet, or a communication line, such as a telephone line.

The program may be transmitted from the computer system which has this program stored in its memory device or the like to another computer system via a transmission medium or a transmission wave in the transmission medium. The “transmission medium” by which the program is transmitted is a medium which has a capability of transmitting information, such as a network (communication network) like the Internet, or a communication line, such as a telephone line. The program may be designed to accomplish some of the aforementioned functions. The program may also be one which can realize the aforementioned functions by a combination with a program already recorded in the computer system or a so-called difference file (difference program).

The embodiment may be designed in such a manner as to realize some of the components by exclusive circuits while realizing the other components by allowing a general-purpose microprocessor to execute a program which accomplishes the functions of the components. In such a modification, a specific-purpose processor may be used instead of the general-purpose processor.

In case where the image pickup apparatus embodying the invention is realized by using a computer system, such as a personal computer, some of the functions that are accomplished by the subject area extracting program may be realized in the form of an external exclusive unit.

Various embodiments and changes may be made thereunto without departing from the broad spirit and scope of the invention. The above-described embodiments are present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2000-398184 filed on Dec. 27, 2000, and including specification, claims, drawings and summary. The disclosure of the above Japanese Patent Application is incorporated herein by reference in its entirety.

What is claimed is:

1. An image pickup apparatus for extracting a subject area from a picked-up image of a target object as a subject, comprising:
a space-frequency characteristic pattern irradiating section which irradiates a visible light which has passed through an optical filter having a predetermined space-frequency characteristic to said target object;
a camera for picking up said target object;
a difference image generating section which generates a difference image between a first image picked up by said camera when said visible light is irradiated from said space-frequency characteristic pattern irradiating section and a second image picked up by said camera when said visible light is not irradiated from said space-frequency characteristic pattern irradiating section;
a space-frequency domain transforming section which transforms said difference image generated by said difference image generating section to a space-frequency domain to acquire a space-frequency characteristic of each pixel of said difference image;
a space-frequency pattern collating section which collates said space-frequency characteristic of each pixel acquired by said space-frequency domain transforming section with said space-frequency characteristic of said optical filter; and
a subject image generating section which generates a subject image from which said subject area has been extracted based on a result of collation performed by said space-frequency pattern collating section.

2. The image pickup apparatus according to claim 1, wherein said optical filter has a space-frequency characteristic which localizes a power spectrum to a predetermined space-frequency when said difference image is transformed to said space-frequency domain.

3. The image pickup apparatus according to claim 2, wherein said optical filter is an optical filter whose visible light transparency rate changes in a sine wave form.

4. The image pickup apparatus according to claim 1, wherein said space-frequency domain transforming section transforms a difference image into the space-frequency domain by Fourier transform.

5. The image pickup apparatus according to claim 1, wherein said space-frequency domain transforming section transforms a difference image into the space-frequency domain by discrete cosine transform.

6. The image pickup apparatus according to claim 1, wherein said difference image generating section acquires first average brightness of said first image and second average brightness of said second image and determines, based on the first average brightness and the second average brightness, that said first is an image picked up by said camera when said visible light is irradiated and said second image is an image picked up by said camera when said visible light is not irradiated.

7. An image pickup apparatus for extracting a subject area from a picked-up image of a target object as a subject, comprising:
a space-frequency characteristic pattern irradiating section for irradiating a visible light which has passed through an optical filter having a predetermined space-frequency characteristic to said target object;
camera for picking up said target object;
a processor; and
a storage which stores a program to be executed by said processor, wherein said processor:
generates a difference image between a first image picked up by said camera when said visible light is irradiated from said space-frequency characteristic pattern irradiating section and a second image picked up by said camera when said visible light is not irradiated from said space-frequency characteristic pattern irradiating section;
transforms said generated difference image to a space-frequency domain to acquire a space-frequency characteristic of each pixel of said difference image;
collates said acquired space-frequency characteristic of each pixel with said space-frequency characteristic of said optical filter; and
generates a subject image from which said subject area has been extracted based on a result of collation performed by said space-frequency pattern collating section.

8. The image pickup apparatus according to claim 7, wherein said optical filter is an optical filter whose visible light transparency rate changes in a sine form.

9. The image pickup apparatus according to claim 7, wherein said processor transforms a difference image into the space-frequency domain by Fourier transform to thereby acquire said space-frequency characteristic of each pixel of said difference image.

10. The image pickup apparatus according to claim 7, wherein said processor transforms a difference image into the space-frequency domain by discrete cosine transform to thereby acquire said space-frequency characteristic of each pixel of said difference image.

11. The image pickup apparatus according to claim 7, wherein said space-frequency characteristic pattern irradiating section includes:
said optical filter;
a light source which irradiates light to said target object via said optical filter; and
a light source controller which controls ON and OFF states of said light source, and informs said processor of whether said light source is in said ON state or said OFF state.

12. The image pickup apparatus according to claim 7, wherein said processor acquires first average brightness of said first image and second average brightness of said second image and determines, based on the first average brightness and the second average brightness, that said first image is an image picked up by said camera when said visible light is irradiated and said second image is an image picked up by said camera when said visible light is not irradiated.

13. A subject area extracting method for extracting a subject area from a picked-up image of a target object as a subject, comprising the steps of:
irradiating a visible light which has passed through an optical filter having a predetermined space-frequency characteristic to said target object;
generating a difference image between a first image picked up when said visible light is irradiated and a second image picked up when said visible light is not irradiated;
transforming said generated difference image to a space-frequency domain to acquire a space-frequency characteristic of each pixel of said difference image;
collating said acquired space-frequency characteristic of each pixel with said space-frequency characteristic of said optical filter; and
generating a subject image from which said subject area has been extracted based on a result of collation.

14. The subject area extracting method according to claim 13, wherein said optical filter is an optical filter whose visible light transparency rate changes in a sine wave form.

15. The subject area extracting method according to claim 13, wherein a difference image is transformed into the space-frequency domain by Fourier transform at a time of acquiring said space-frequency characteristic of each pixel of said difference image.

16. The subject area extracting method according to claim 13, wherein a difference image is transformed into the space-frequency domain by discrete cosine transform at a time of acquiring said space-frequency characteristic of each pixel of said difference image.

17. The subject area extracting method according to claim 13, wherein at a time of generating said difference image, acquiring first average brightness of said first image and second average brightness of said second image and determining, based on the first average brightness and the second average brightness, that said first image is an image picked up when said visible light is irradiated and said second image is an image picked up when said visible light is not irradiated.

18. A program which makes a computer:
generate a difference image between a first image picked up when a visible light which has passed through an optical filter having a predetermined space-frequency characteristic is irradiated to a target object as a subject and a second image picked up when said visible light is not irradiated to said target object;
transform said generated difference image to a space-frequency domain to acquire a space-frequency characteristic of each pixel of said difference image;
collate said acquired space-frequency characteristic of each pixel with said space-frequency characteristic of said optical filter; and
generate a subject image from which said subject area has been extracted based on a collation result.

19. The program according to claim 18, wherein a difference image is transformed into the space-frequency domain by Fourier transform at a time of acquiring said space-frequency characteristic of each pixel of said difference image.

20. The program according to claim 18, wherein a difference image is transformed into the space-frequency domain by discrete cosine transform at a time of acquiring said space-frequency characteristic of each pixel of said difference image.

21. The program according to claim 18, wherein at a time of generating said difference image, said program makes the computer acquire first average brightness of said first image and second average brightness of said second image and determine, based on the first average brightness and the second average brightness, incd that said first image is an image picked up when said visible light is irradiated and said second image is an image picked up when said visible light is not irradiated.
